(19) United States
(12) Patent Application Publication
(10) Pub. No.: US 2014/0001825 A1
(43) Pub. Date: Jan. 2, 2014

(54) TRACK IDLER

(71) Applicant: Caterpillar Inc., Peoria, IL (US)

(72) Inventor: David J. Hakes, Brimfield, IL (US)

(73) Assignee: Caterpillar Inc.

(21) Appl. No.: 13/926,701

(22) Filed: Jun. 25, 2013

Related U.S. Application Data
(60) Provisional application No. 61/666,538, filed on Jun. 29, 2012.

(51) Int. Cl. B62D 55/14

(52) U.S. Cl. CPC B62D 55/14
USPC 305/136

(57) ABSTRACT

A track idler includes a. hub having a first portion and a second portion. The track idler may also include a first web extending radially outward from the first portion of the hub, the first web and the first portion of the hub being formed from a single, unitary piece of parent material. Additionally, the track idler may include a second web spaced laterally from the first web, the second web extending radially outward from the second portion of the hub, the second web and the second portion of the hub being formed from a single, unitary piece of parent material.

### CROSS-REFERENCE TO RELATED APPLICATION

This application claims the benefit of U.S. Provisional Patent Application No. 61/666,538, filed Jun. 29, 2012, which is hereby incorporated by reference in its entirety.

### TECHNICAL FIELD

The present disclosure relates to track assemblies for mobile machines and, more particularly, to idlers for such track assemblies.

### BACKGROUND

Many mobile machines have undercarriages with track assemblies that move along the ground as the machine travels. For example, many earthmoving machines like tractors and excavators may have such track assemblies. These track assemblies typically include an endless track that extends around various components that guide the endless track. In many track assemblies, the components that guide the endless track include a track idler that guides one end of the endless track.

FIGS. 1A and 1B show a prior art idler 414 for a track assembly. Idler 414 is constructed of numerous components secured to one another. Idler 414 includes a hub 416 and a body 418. Body 418 includes webs 422 and a rim 424. Webs 422 are frustoconical discs that are welded to hub 416. Webs 422 extend radially outward from hub 416. Rim 424 extends around radially outer portions of webs 422. Rim 424 is welded to the radially outer portions of webs 422.

The configuration of idler 414 shown in FIGS. 1A and 1B may have certain benefits for some applications. However, the design of idler 414 may also have certain drawbacks. Making idler 414 may involve numerous time-consuming and expensive manufacturing processes. For example, welding the numerous components of idler 414 together may require significant time and effort, which may drive up the cost of idler 414. The disclosed embodiments may help solve these issues.

### SUMMARY

One disclosed embodiment relates to a track idler. The track idler may include a huh having a first portion and a second portion. The track idler may also include a first web extending radially outward from the first portion of the hub, the first web and the first portion of the hub being thrilled from a single, unitary piece of parent material. Additionally, the track idler may include a second web spaced laterally from the first web, the second web extending radially outward from the second portion of the hub, the second web and the second portion of the hub being formed from a single, unitary piece of parent material.

Another disclosed embodiment relates to a track idler. The track idler may include a hub. The track idler may also include a first web extending radially outward from the hub. The track idler may also include a first annular tread surface connected to the first web, the first annular tread surface and the first web being constructed from a single, unitary piece of parent material. Additionally, the track idler may include a second web extending radially outward from the hub, the second web being laterally spaced relative to the first web. The track idler may also include a second annular tread surface connected to the second web, the second annular tread surface and the second web being constructed from a single, unitary piece of parent material.

A further disclosed embodiment relates to a track idler. The track idler may include a first forging forming a first lateral half of the track idler. The track idler may also include a second forging forming a second lateral half of the track idler, the first forging and the second forging being joined at a middle portion of the track idler.

### BRIEF DESCRIPTION OF THE DRAWINGS

FIG. 1A is a perspective view of a prior art track idler;

FIG. 1B is a cross-section of a prior art track idler;

FIG. 2 is a side view of a machine with which a track idler according to the present disclosure may be used;

FIG. 3 is a perspective view of a portion of a link assembly with which a track idler according to the present disclosure may be used;

FIG. 4A is a perspective view of a track idler according to the present disclosure;

FIG. 4B is a front view of a track idler according to the present disclosure; and

FIG. 4C is a cross-section of a track idler according to the present disclosure.

### DETAILED DESCRIPTION

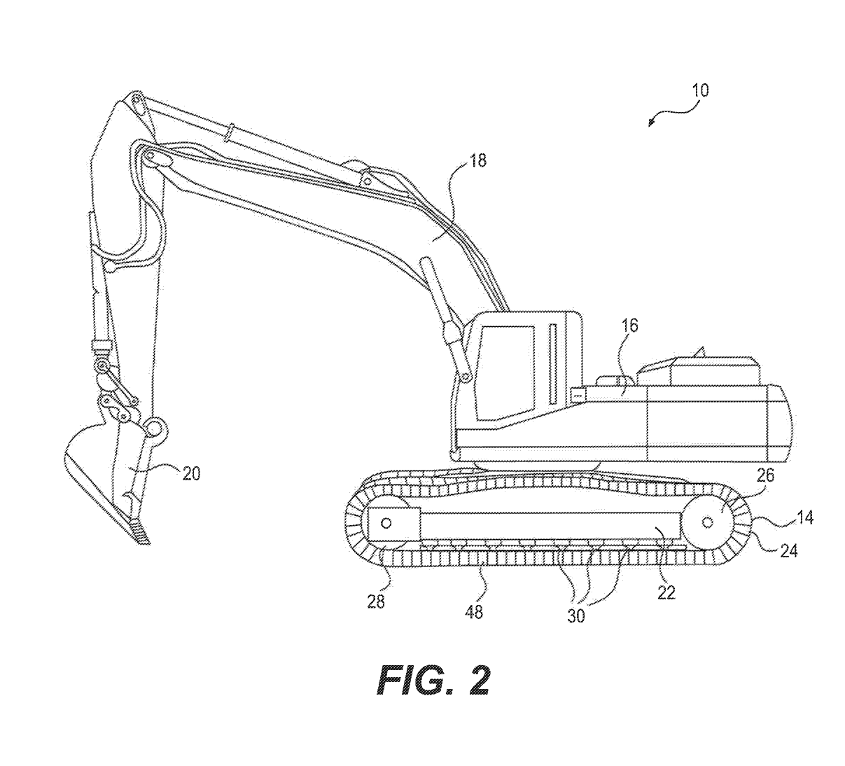

FIG. 2 illustrates a machine 10 with a track assembly 14 that may use an idler 28 according to the present disclosure. Machine 10 may include a pair of track assemblies 14, only one of which is shown in FIG. 2. Machine 10 may be any type of machine that includes an undercarriage with one or more track assemblies 14. In the example shown in FIG. 2, machine 10 is an excavator having a superstructure 16 pivotally supported from the undercarriage. In this embodiment, machine 10 may include an implement 18, which may have an excavating bucket 20 attached to it for digging. Machine 10 may alternatively be another type of machine, including, but not limited to, a track-type tractor.

Each track assembly 14 may be configured to support machine 10 from and move along the ground, roads, and/or other types of terrain. Each track assembly 14 may include a track roller frame 22, various guide components engaged to track roller frame 22, a drive sprocket 26, an idler 28, rollers 30, and an endless track 24 extending around drive sprocket 26, idler 28, and rollers 30.

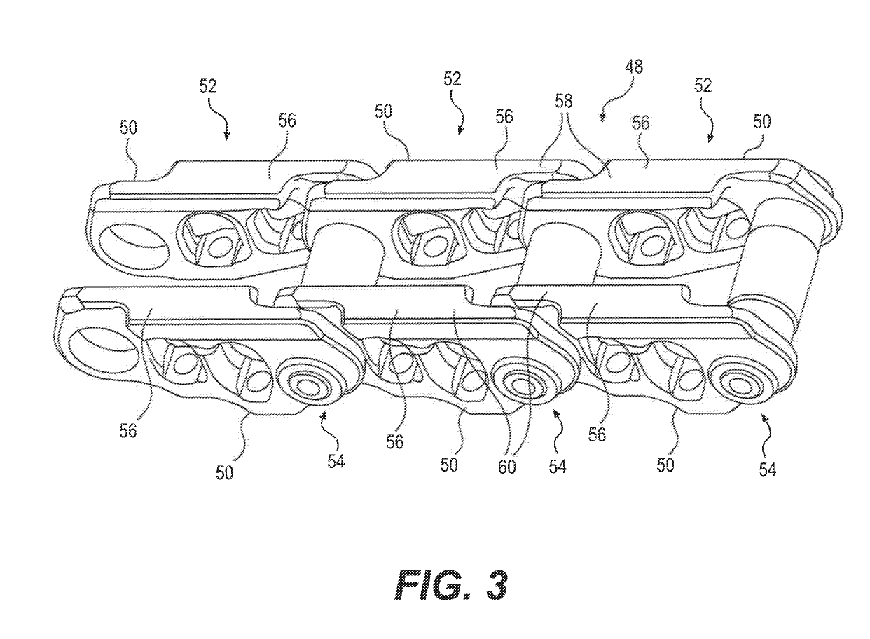

Track 24 may include a link assembly 48 that forms a flexible backbone of track 24, as well as a plurality of shoes (not shown) secured to outer surfaces of link assembly 48. FIG. 3 shows a short section of link assembly 48. Link assembly 48 may include a plurality of links 50 connected to one another in laterally spaced pairs 52 pivotally connected to one another at pivot joints 54. Each link 50 may include a roller rail 56. Roller rails 56 of links 50 may collectively form a first roller rail 58 and a second roller rail 60 of link assembly 48. Link assembly 48 may extend in an endless chain around drive sprocket 26, rollers 30, and idler 28.

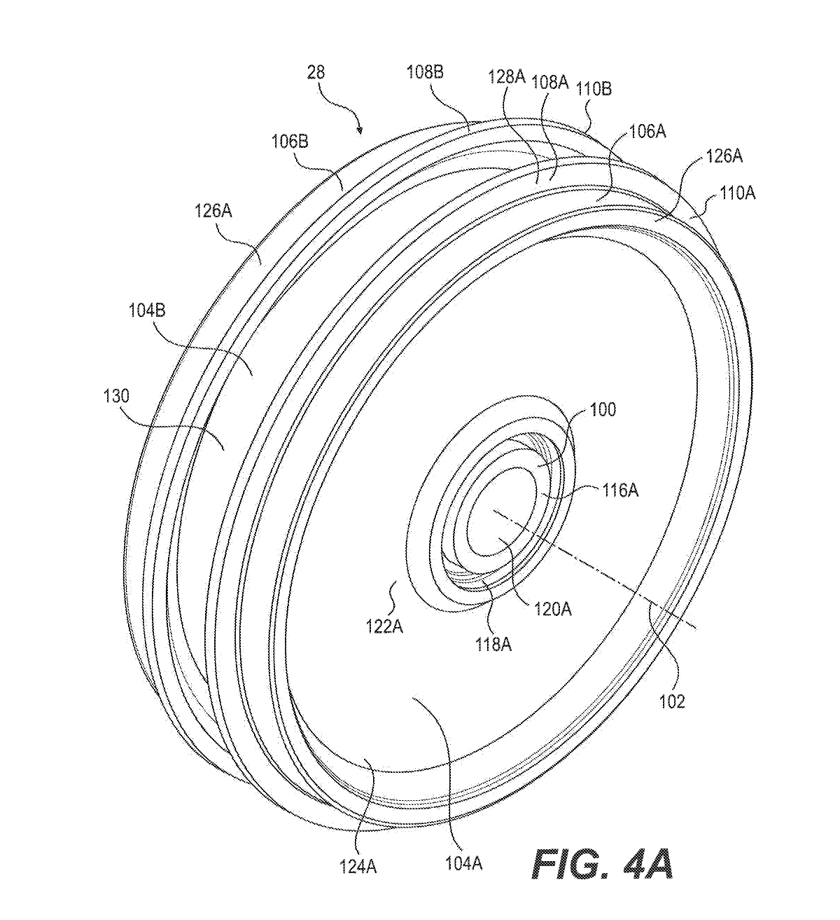

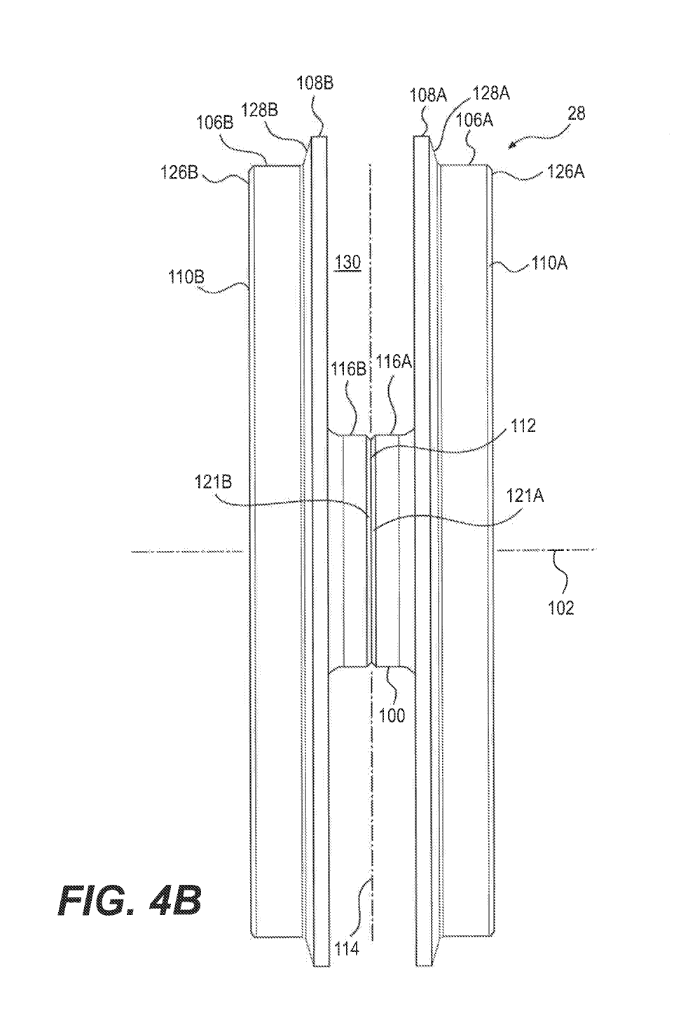

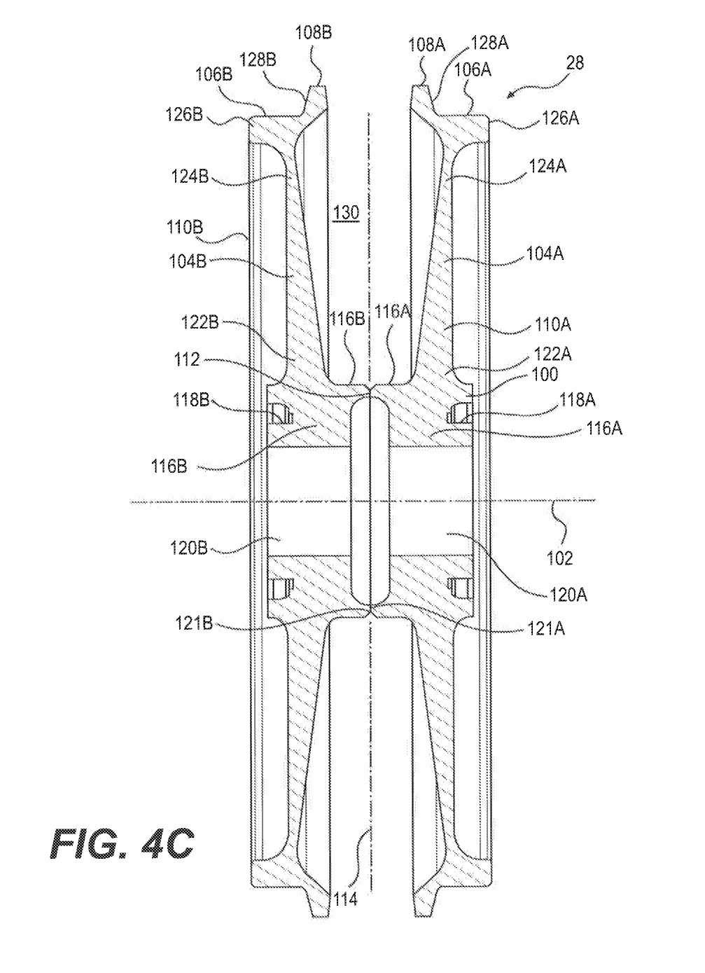

FIGS. 4A-4C show one embodiment of an idler 28 according to the present disclosure. Idler 28 may include a huh 100 configured to be connected to track roller frame 22 in a manner such that idler 28 may rotate about a rotational axis 102. Idler 28 may also include webs 104A, 104B, annular tread surfaces 106A, 106B, and guide flanges 108A, 108B. Idler 28 may be constructed of various materials, in some embodiments, idler 28 may be constructed of metal. For example, idler 28 may be constructed of a ferrous metal, such as steel or iron.

As best shown in FIGS. 4B and 4C, in some embodiments, idler 28 may be constructed of two pieces 110A, 110B secured to one another at a joint 112. Joint 112 may be disposed in a middle portion of idler 28, such as along a center plane 114 that extends perpendicular to rotation axis 102 through the lateral center of idler 28. For purposes of this disclosure, use of the terms “lateral” and “laterally” in connection with features of idler 28 refers to directions along or parallel to rotational axis 102. In some embodiments, each piece 110A, 110B may be constructed from a single, unitary piece of parent material. For example, in some embodiments, each piece 110A, 110B may be a forging, a casting, or a piece formed from machining a billet or other piece of metal stock. Structures formed from a single, unitary piece of parent material may include structures that are formed without welded joints, glued joints, fastened joints, press-fit joints, or the like to hold different portions of the structure together.

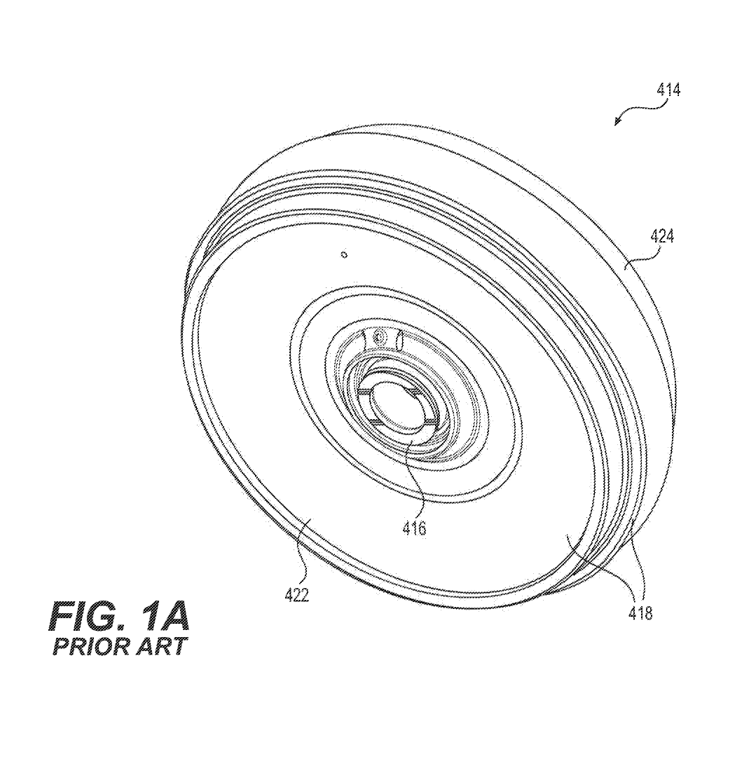

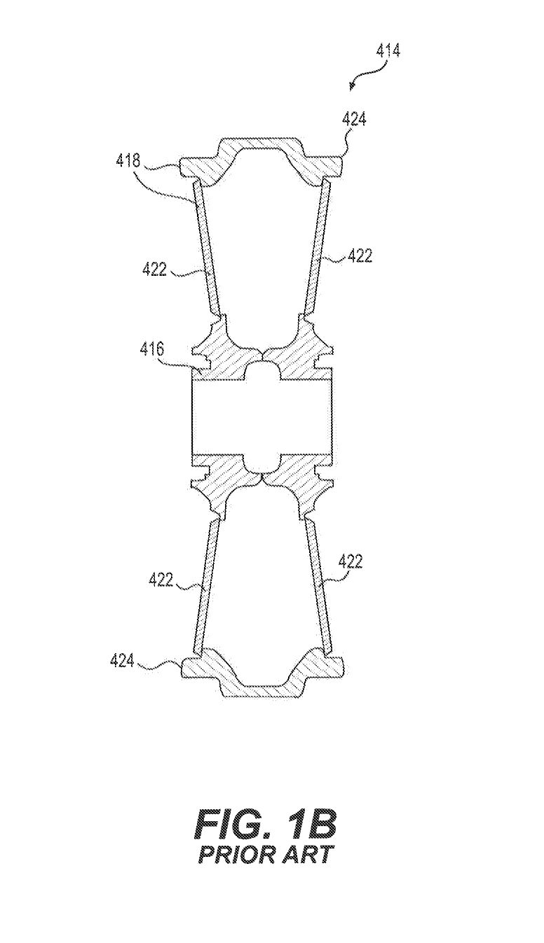

As best shown in FIG. 1C, piece 110A may include web 104A, annular tread surface 106A, guide flange 108A, and a first portion 116A of hub 100. Thus, all of these structures may be formed from a single, unitary piece of parent material. In some embodiments, first portion 116A of hub 100 may include a generally cylindrical body. First portion 116A of huh 100 may have a central passage 120A extending along rotational axis 102. As shown in FIG. 4C, different axial portions of central passage 120A may have different cross-sectional sizes, First portion 116A of huh 100 may also include journal structure 118A for rotationally engaging huh 100 to one or more components connected to track roller frame 22. Journal structure 118A may be configured to engage components that include, but are not limited to, bearings, axles, and/or spindles. At joint 112, first portion 116A of hub 100 may have mating structure 121A. Mating structure 121 A may include, for example, a planar surface extending coincident with center plane 114 of idler 28.

Web 104A may extend radially outward from and circumferentially around first portion 116A of hub 100. Web 104A may have a solid construction as shown in the drawings, or it may have one or more openings. Web 104A may include a radially inner portion 122A and a radially outer portion 124A. Radially inner portion 122A may extend from outer portions of the generally cylindrical body forming first portion 116A of hub 100. Web 104A may be spaced laterally from mating structure 121A and, thus, from center plane 114 of idler 28.

In some embodiments, the thickness of web 104A may vary as it extends radially outward. For example, the thickness of web 104A may decrease as it extends radially outward from the first portion 116A of hub 100. in some embodiments, the thickness of web 104A may gradually taper down as it extends radially outward. This may provide efficient material usage, as it places more material in the web at the radial inner portion 122A, where greater strength is needed to withstand higher bending moments.

Web 104A may have other features that help it withstand the loads experienced in use. For example, as best shown in FIG. 4C, web 104C may have concave radiused surfaces on both sides adjacent its radially inner and outer portions 122A, 124A. These concave radiused surfaces may help suppress stress concentrations at the radially inner and outer portions 122A, 124A.

Annular tread surface 106A may be connected directly or indirectly to web 104A. For example, as shown. in FIG. 4C, annular tread surface 106A may be formed on a flange 126A connected to radially outer portion 124A of web 104A. Flange 126A may extend substantially concentric with rotational axis 102 and generally in a direction parallel to rotational axis 102. Annular tread surface 106A may also extend substantially concentric with rotational axis 102. Additionally, in some embodiments, annular tread surface 106A may also extend generally parallel to rotational axis 102. Like web 104A, annular tread surface 106A and flange 126A may be spaced laterally from mating structure 121A and, thus, from center plane 114 of idler 28, in some embodiments, one end of annular tread surface 106A and flange 126A may be disposed laterally inward of radially outer portion 124A of web 104A, and an opposite end of tread surface 106A and flange 126A may be disposed laterally outward of radially outer portion 124A of web 104A.

Guide flange 108A may be directly or indirectly connected to web 104A. For example, in the embodiment shown in FIGS. 4A-4C, guide flange 108A may extend from the laterally inner end of flange 126A. Guide flange 108A may extend radially outward of annular tread surface 106A. As shown in the drawings, in some embodiments, the base of guide flange 108A may be disposed directly adjacent annular tread surface 106A. Alternatively, guide flange 108A may have its base at various other places. Guide flange 108A may have a guide surface 128A on its laterally outer side. Guide surface 128A may extend radially outward of annular tread surface 106A. As shown in FIG. 4C, in some embodiments, guide surface 128A may angle as it extends radially outward.

Similar to piece 110A of idler 28, piece 110B may include web 104B, annular tread surface 106B, guide flange 108B, and a second portion 1168 of hub 100. As shown in FIGS. 4B and 4C, in some embodiments, piece 110B and its web 104B, annular tread surface 106B, guide flange 108B, and second portion 116B of hub 100 may have a construction substantially identical to piece 110A and the structures thereof, except that piece 110B may be mirrored relative to center plane 114.

At joint 112, mating structures 121A, 121B of first and second portions 116A, 116B of hub 100 may be secured to one another to secure pieces 110A, 110B to one another. Various means may be used to secure mating structures 121A, 121B at joint 112. In some embodiments, mating structures 121A, 121B may be welded to one another.

With first and second hub portions 116A, 116B secured to one another at joint 112, web 104A, annular tread surface 106A, and guide flange 108A may be spaced laterally from web 104B, annular tread surface 1068, and guide flange 108B. An annular gap 130 may extend through the radially outermost portion of idler 28 to adjacent the mating structures 121A, 121B of first and second portions 116A, 116B of hub 100. Gap 130 may separate web 104A, annular tread surface 106A, and guide flange 108A from web 104B, annular tread surface 106B, and guide flange 108B. In some embodiments, idler 28 may have no structure extending across gap 130 radially outward of hub 100.

Annular tread surfaces 106A, 106B and guide flanges 108A, 108B may be configured to engage link assembly 48 of track 24. In some embodiments, guide flanges 108A, 108B may be laterally spaced from one another by a distance slightly less than the lateral spacing between roller rails 58, 60 of link assembly 48. This may allow idler 28 to engage link assembly 48 with annular tread surfaces 106A, 106B abutting roller rails 58, 60 and guide flanges 108A, 108B extending between roller rails 58, 60 to provide lateral guidance between idler 28 and link assembly 48.

Idler 28 is not limited to the configurations shown in the drawings and discussed above. For example, pieces 110A, 110B may be unitary pieces other than forgings, including, but not limited, to castings and/or billet parts. In addition, in embodiments where pieces 110A, 110B are forgings or castings, they may include various features formed by machining and/or other shaping operations.

Furthermore, pieces 110A, 110B may be secured at joint 112 by means other than welding, such as by use of press-fitting, fasteners, and the like. Additionally, pieces 110A, 110B may be secured to one anther at other places, in addition to, or instead of at joint 112. For example, in some configurations, each piece 110A, 110B may have structures extending laterally inward from guide flanges 108A, 108B and closing gap 130 at the radial outer perimeter of idler 28. Such structures may be secured to one another by various means, including, but not limited to, welding, press-fitting, and/or fastening, Additionally, idler 28 may have more than two unitary pieces 110A, 110B joined to one another to form the hub 100, webs 104A, 104B, annular guide surfaces 106A, 106B, and guide flanges 108A, 108B.

Also, the various features of pieces 110A, 110B may have different shapes and/or positions than described. For example, annular tread surfaces 106A, 106B and guide flanges 108A, 108B may have different configurations designed to engage link assembly 48 in different manners.

### INDUSTRIAL APPLICABILITY

The disclosed idler 28 may have use in any application requiring a track system for a mobile machine. The disclosed configurations of idler 28 may provide a number of advantages. For example, the disclosed configurations may provide a cost-effective, durable idler 28.

The disclosed configurations may allow making idler 28 with a limited number of manufacturing steps. The manufacturer need only make the two pieces 110A, 110B, join them, and perform any necessary finishing operations.

Each piece 110A, 110B may be constructed from a single, unitary piece of parent material using processes such as forging, casting, or machining from billet. Because each piece 110A, 110B includes only one of webs 104A, 104B, pieces 110A, 110B may be readily forged or cast without complications related to die lock or molding issues.

Once pieces 110A, 110B are formed, they may be brought together and secured to one another. For example, as noted above, pieces 110A, 110B may be welded together at joint 112. Any type of welding process may be used to secure pieces 110A, 110B to one another at joint 112. For example, arc welding may be used, in which case gap 130 may advantageously provide access to weld joint 112. Alternatively, friction welding may he used by abutting mating structures 121A, 121B against each other and generating relative rotation between pieces 110A, 110B to generate heat at mating structures 121A, 121B and weld them together.

The disclosed configurations also include certain features that may provide idler 28 with considerable strength and durability. For example, constructing portion 116A of huh 100, web 104A, annular roller tread 106A, and guide flange 108A from a single, unitary piece of parent material may provide desirable strength at the junctures between these structures. Additionally, constructing these components from a single, unitary piece of parent material may make it easier to provide stress relieving features like radiuses at the junctures between these components. Similar advantages apply to piece 110B.

it will be apparent to those skilled in the art that various modifications and variations can be made in the disclosed systems without departing from the scope of the disclosure. Other embodiments of the disclosed systems will be apparent to those skilled in the art from consideration of the specification and practice of the systems disclosed herein. It is intended that the specification and examples be considered as exemplary only, with a true scope of the disclosure being indicated by the following claims and their equivalents.

What is claimed is:

1. A track idler, comprising:
a hub having a first portion and a second portion;
a first web extending radially outward from the first portion of the huh, the first web and the first portion of the huh being formed from a single, unitary piece of parent material; and
a second web spaced laterally from the first web, the second web extending radially outward from the second portion of the hub, the second web and the second portion of the hub being formed from a single, unitary piece of parent material.

2. The track idler of claim 1, wherein the first and second portions of the hub are formed from separate pieces of parent material secured to one another at a joint.

3. The track idler of claim 2, wherein the first and second portions of the hub are joined to one another at the joint by a weld.

4. The track idler of claim 3, wherein the joint extends along a center plane of the track idler.

5. The track idler of claim 3, wherein:
a thickness of the first web decreases as the first web extends radially outward from the first portion of the hub; and
a thickness of the second web decreases as the second web extends radially outward from the second portion of the hub.

6. The track idler of claim 2, wherein the track idler includes an annular gap between the first and second webs, the annular gap extending from a radially outer portion of the idler to adjacent the joint between the first and second portions of the hub.

7. The track idler of claim 2, wherein the joint extends along a center plane of the track idler.

8. The track idler of claim 1, wherein:
a thickness of the first web decreases as the first web extends radially outward from the first portion of the hub; and
a thickness of the second web decreases as the second web extends radially outward from the second portion of the hub.

9. The track idler of claim 1, wherein the first and second webs are connected to one another only through the hub.

10. A track idler, comprising:
a hub;
a first web extending radially outward from the hub;
a first annular tread surface connected to the first web, the first annular tread surface and the first web being constructed from a single, unitary piece of parent material;
a second web extending radially outward from the hub, the second web being laterally spaced relative to the first web; and
a second annular tread surface connected to the second web, the second annular tread surface and the second web being constructed from a single, unitary piece of parent material.

11. The track idler of claim 10, wherein:
the track idler further comprises a first guide flange extending radially outward of the first annular tread surface, wherein the first guide flange, the first annular tread surface, and the first web are formed from. a single, unitary piece of parent material; and
the track idler further comprises a second guide flange extending radially outward of the second annular tread surface, wherein the second guide flange, the second annular tread surface, and the second web are formed from a single, unitary piece of parent material.

12. The track idler of claim 11, wherein an annular gap extending through a radially outermost portion of the track idler separates the first annular tread surface and the first guide flange from the second annular tread surface and the second guide flange.

13. The track idler of claim 12, wherein the annular gap further extends between the first web and the second web to adjacent the hub.

14. The track idler of claim 10, wherein:
the first web, the first annular tread surface, and a first portion. of the hub are formed from a single, unitary piece of parent material; and
the second web, the second annular tread surface, and a second portion of the hub are formed from a single unitary piece of parent material.

15. The track. idler of claim 10, wherein;
the first web, the first annular tread surface, and a first portion of the hub are formed from a first single, unitary piece of parent material;
the second web, the second annular tread surface, and a second portion of the hub are formed from a second single, unitary piece of parent material; and
the first and second unitary pieces of material are joined to one another at a joint,

16. A track idler, comprising:
a first forging forming a first lateral half of the track idler;
a second forging forming a second lateral half of the track idler, the first forging and the second forging being joined at a middle portion of the track idler.

17. The track idler of claim 16, wherein:
the first forging includes
a first huh portion, and
a first web extending radially outward from the first hub portion, and
a first annular tread surface; and
the second forging includes
a second hub portion,
a second web extending radially outward from the second hub portion, and
a second annular tread surface.

18. The track idler of claim 17, wherein:
the first forging further comprises a first guide surface extending radially outward of
the first annular tread surface; and
the second forging further comprises a second guide surface extending radially outward of the second annular tread surface.

19. The track idler of claim 18, wherein an annular gap extends through a radially outermost portion of the track idler and separates the first annular tread surface and the first guide flange from the second annular tread surface and the second guide flange.

20. The track idler of claim 19, wherein the annular gap further extends between the first web and the second web to adjacent the first huh portion and the second hub portion.
